(19) United States
(12) Patent Application Publication
(10) Pub. No.: US 2025/0307745 A1
(43) Pub. Date: Oct. 2, 2025

(54) CALCULATING CARBON COST OF INDIVIDUAL WORKLOAD IN A DATA CENTER

(71) Applicant: Karthik Krishna, bangalore (IN)

(72) Inventor: Karthik Krishna, bangalore (IN)

(21) Appl. No.: 18/823,690

(22) Filed: Sep. 4, 2024

Related U.S. Application Data
(60) Provisional application No. 63/573,440, filed on Apr. 2, 2024.
(60) Provisional application No. 63/573,442, filed on Apr. 2, 2024.
(60) Provisional application No. 63/573,443, filed on Apr. 2, 2024.
(60) Provisional application No. 63/573,446, filed on Apr. 2, 2024.
(60) Provisional application No. 63/573,450, filed on Apr. 2, 2024.

(51) Int. Cl. G06Q 10/0633; G06F 9/50

(52) U.S. Cl. CPC G06Q 10/0633; G06F 9/5038

(57) ABSTRACT

In one aspect, a computerized method for calculating a carbon cost of individual workload in a data center comprising: performing Application Discovery and Dependency Mapping (ADDM) of one or more individual applications of the data center; with an ADDM output from the ADDM, generating an ADDM graph; determining each component of each individual application of one or more individual applications of the data center, wherein a component comprises a hardware component or a software component of each individual application; implementing a components mapping of each component of each individual application into the ADDM graph, wherein, with the ADDM graph, a plurality of components are represented as nodes and the connectivity between the nodes represented as edges, wherein based on a knowledge of the data-center environment, wherein each component is identified to correspond to each hardware component or each software component; implementing a workload in the data center, wherein the workload comprises a set of one or more tasks which are performed over a time period towards a specific goal; implementing a workload manager, wherein the workload manager executes the set of tasks in the workload, wherein a path of execution of the set of tasks is defined as the workflow; with the ADDM, ADDM graph and Component Resource Utilization, calculating a carbon cost of individual workload in a data center of the workload to generate a carbon footprint calculation.

### CLAIMS OF PRIORITY

This application claims priority to U.S. Provisional Patent Application No. 63/573,440, filed on Apr. 2, 2024, and titled DATA CENTER METHODS. This provisional patent application is hereby incorporated by reference in its entirety.

This application claims priority to U.S. Provisional Patent Application No. 63/573,442, filed on Apr. 2, 2024, and titled DATA CENTER METHODS. This provisional patent application is hereby incorporated by reference in its entirety.

This application claims priority to U.S. Provisional Patent Application No. 63/573,443, filed on Apr. 2, 2024, and titled DATA CENTER METHODS. This provisional patent application is hereby incorporated by reference in its entirety.

This application claims priority to U.S. Provisional Patent Application No. 63/573,446, filed on Apr. 2, 2024, and titled DATA CENTER METHODS. This provisional patent application is hereby incorporated by reference in its entirety.

This application claims priority to U.S. Provisional Patent Application No. 63/573,450, filed on Apr. 2, 2024, and titled DATA CENTER METHODS. This provisional patent application is hereby incorporated by reference in its entirety.

### SUMMARY OF THE INVENTION

In one aspect, a computerized method for calculating a carbon cost of individual workload in a data center comprising: performing Application Discovery and Dependency Mapping (ADDM) of one or more individual applications of the data center; with an ADDM output from the ADDM, generating an ADDM graph; determining each component of each individual application of one or more individual applications of the data center, wherein a component comprises a hardware component or a software component of each individual application; implementing a components mapping of each component of each individual application into the ADDM graph, wherein, with the ADDM graph, a plurality of components are represented as nodes and the connectivity between the nodes represented as edges, wherein based on a knowledge of the data-center environment, wherein each component is identified to correspond to each hardware component or each software component; implementing a workload in the data center, wherein the workload comprises a set of one or more tasks which are performed over a time period towards a specific goal; implementing a workload manager, wherein the workload manager executes the set of tasks in the workload, wherein a path of execution of the set of tasks is defined as the workflow; with the ADDM, ADDM graph and Component Resource Utilization, calculating a carbon cost of individual workload in a data center of the workload to generate a carbon footprint calculation.

### BACKGROUND

Currently in a data center where several workloads are running, we are able to identify the carbon footprint for either at the level of instances (or any IaaS like Bare-metal) used and the carbon footprint of services/software (PaaS) used for running all the applications and workloads over a period of time. That is, carbon footprint available currently is at either Infrastructure or Instances or at Service level for the resources used by applications and workloads. There is no defined method or process for identifying the carbon footprint or carbon cost of running a workload which could be interacting with one or more applications.

Additionally, in a data-center like environment, there can be many users creating many applications for various projects. Over time it may become challenging to track the different components and their inter-dependencies for a particular application. Application discovery and dependency mapping (ADDM) is the process of identifying the dependencies of individual components of the application. Results of an ADDM is a graph with these individual components represented as nodes and the connectivity between the nodes represented as edges. There are multiple methodologies for doing ADDM available in the market today. However, improvements to these methodologies are also desired.

### BRIEF DESCRIPTION OF THE DRAWINGS

FIG. 1 illustrates an example process for identifying an application using ADDM, components in an application, and resource utilization table in a data center, according to some embodiments.

FIG. 2 illustrates an example table of components resource utilization for Iaas model, according to some embodiments.

FIG. 3 illustrates an example table of components resource utilization for on-premise model, according to some embodiments.

FIG. 4 illustrates an example table of components resource usage for Paas model, according to some embodiments.

FIG. 5 illustrates an example table of energy consumed in kw (kilo watt) for one (1) hour over average utilization specified, according to some embodiments.

FIG. 6 illustrates an example process for using components resource utilization and/or usage of the applications in a data center discovered to identify the carbon footprint of each of the application, according to some embodiments.

FIG. 7 illustrates an example process for Carbon Footprint Calculation of the Application, according to some embodiments.

FIG. 8 illustrates an example equation for Calculate the carbon footprint of each component with the formula per the GHG protocol, according to some embodiments.

FIG. 9 illustrates an example process 900 for analysis of workloads, according to some embodiments.

FIG. 10 illustrates another example process for, according to some embodiments.

FIG. 11 illustrates an example process for calculating the cost of a workload in a data center, according to some embodiments.

FIG. 12 illustrates an example process for calculating carbon cost of individual workload, according to some embodiments.

FIG. 13 illustrates an example process for identifying intrinsic carbon cost of running a workload, according to some embodiments.

FIG. 14 illustrates an example equation for calculating the cost of a workload, according to some embodiments.

FIG. 15 illustrates an example process for identifying the carbon cost of running a workload, according to some embodiments.

The Figures described above are a representative set and are not an exhaustive with respect to embodying the invention.

### DESCRIPTION

Disclosed are a system, method, and article of manufacture for calculating carbon cost of individual workload in a data center (kgCO₂E). The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application can be a multi-tiered (or a single tiered) architecture with hardware and software components which work cohesively to perform specific tasks to execute a particular function. Multi-tiered in this definition implies multiple interconnected components or layers, each handling specific functionality. An application can be as common as a websites for a restaurant or as complex as ATM for banking. Application could span across a single or multiple data center.

Application Discovery and Dependency Mapping (ADDM) can automate the process of mapping transactions and applications to underlying infrastructure components.

‘Calculate carbon footprint of individual application in a data center’ can include the steps and methodology to identify individual carbon footprint of each application running in the data center. Processes described herein can apply the carbon footprint calculation process as defined by Green House Gas (GHG) Protocol and map it to an individual application.

Capital expenditure or capital expense (CapEx) is the money an organization or corporate entity spends to buy, maintain, or improve its fixed assets, such as buildings, vehicles, equipment, or land. It is considered a capital expenditure when the asset is newly purchased or when money is used towards extending the useful life of an existing asset.

Carbon footprint (e.g. greenhouse gas footprint) is a calculated value or index that makes it possible to compare the total amount of greenhouse gases that an activity, product, company or country adds to the atmosphere. Carbon footprints can be reported in tons of emissions (e.g. CO2-equivalent) per unit of comparison, by way of example.

Cloud computing can be the on-demand availability of computer system resources, especially data storage (e.g. cloud storage) and computing power, without direct active management by the user.

Data center can be a building/structure and/or other dedicated space within a building/structure and/or a group of buildings used to house computer systems and associated components, such as, inter alia: telecommunications and storage systems.

Data center application can be deployed in a data center which could be in a Cloud, Multi-Cloud (e.g. involving one or more clouds), Hybrid (e.g. involves Cloud and On-Premise), Bare-metal on premise or an on-premise cloud (e.g. AWS Outpost®, Google Anthos®, Azure Azurestack®, Openshift®, Openstack®, etc.).

Greenhouse gases (GHGs) are the gases in the atmosphere that raise the surface temperature of planets such as the Earth. GHGs absorb the wavelengths of radiation that a planet emits, resulting in the greenhouse effect.

Operating expense (OpEx) can be an ongoing cost for running a product, business, and/or system.

Platform as a service (PaaS) is a category of cloud-computing services that allow customers to provision, instantiate, run, and manage a modular bundle comprising a computing platform and one or more applications, without the complexity of building and maintaining the infrastructure typically associated with developing and launching the application(s), and to allow developers to create, develop, and package such software bundles.

Task can be a unit of execution of a software feature. An application can have several tasks some taking as little as milliseconds while others could take hours.

### Example Systems and Methods

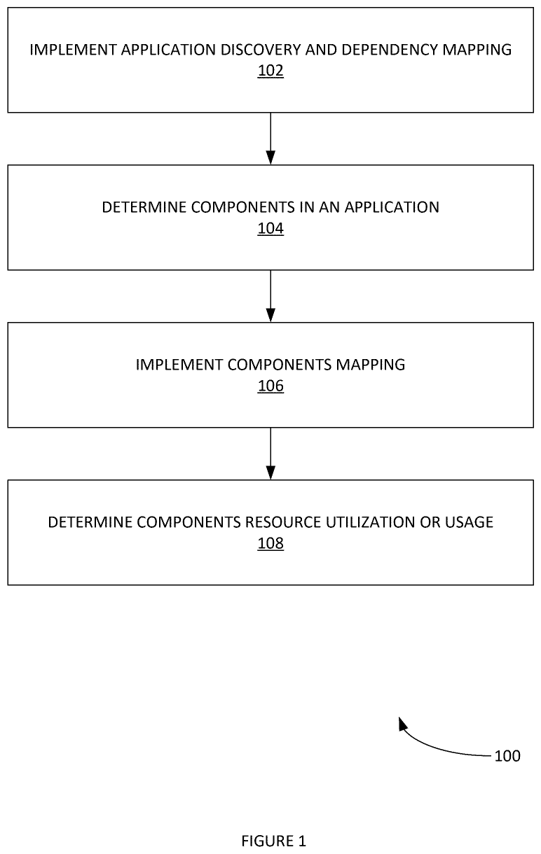

FIG. 1 illustrates an example process for identifying an application using ADDM, components in an application, and resource utilization table in a data center, according to some embodiments. Process 100 can be used to reduce cost, carbon footprint, and risk, increase performance and compliance improved understanding of application and workload utilization/usage. Process 100 is for identifying the carbon footprint at the application level and not the infrastructure or services level.

In step 102, process 100 implements Application Discovery and Dependency Mapping (ADDM). In some embodiments, the ADDM can be running continuously and maintains a graph (e.g. an ADDM graph, etc.) in an updated state.

In step 104, process 100 determines components in an application. Hardware components that can be determined can include Infrastructure-as-a-Service (IaaS). Components can also include, inter alia: servers, containers, virtual machines, etc. Additional components can include storage system such as storage on physical media, object storages (e.g. AWS S3), network attached storage, etc. Other components can include networking systems such as load balancers, software defined network, virtual private cloud, etc. Software components can include software deployed on infrastructure (e.g. BareMetal, VMs) or Platform-as-a-Service (PaaS) offerings in the cloud such as, inter alia: Database, Cache, Serverless, Kubernetes, big data, Spark, streaming analytics, etc.

In step 106, implement components mapping. Results of the ADDM operations can include a graph. The individual components can be represented as nodes and the connectivity between the nodes represented as edges. Based on the knowledge of the data-center environment, each component (e.g. nodes and edges) can be identified to correspond to hardware, software, IaaS or PaaS based on the network address. It is noted that some of the components could be transient.

In step 108, process 100 can determine components resource utilization or usage. Once the component is identified, the utilization (e.g. in an IaaS context) and/or usage (e.g. in a PaaS context) of all the attributes of this component are captured and reported as an average per hour, per day, per week, per month, etc. It is noted that smaller intervals can be used as well (e.g. smaller intervals of 5 mins or 15 mins too can be considered). An example of a node component can be a VM instance. An example of an edge component can be a network.

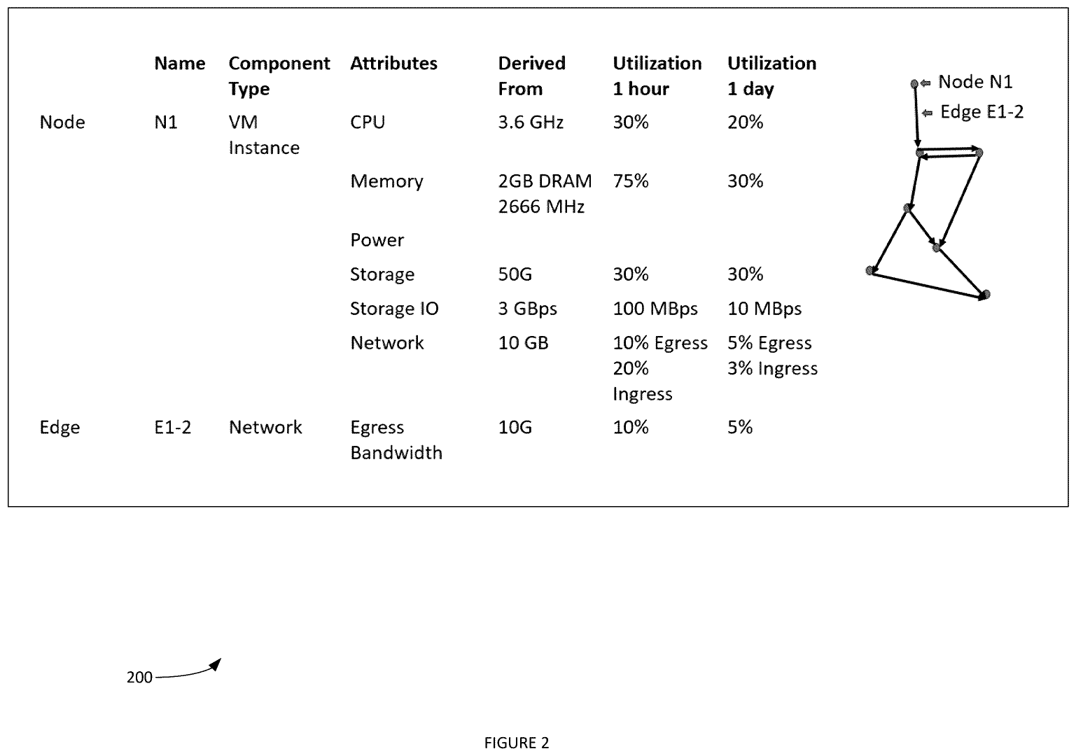

FIG. 2 illustrates an example table of components resource utilization for Iaas model, according to some embodiments. This could be a compute instance (a VM) which can have specific type of CPU having an average utilization for an hour or a day, similarly it could be memory for the compute with a specific amount and specific usage and also specific speed or could be an edge or a network between two components which certain capacity (10G or 40G) with an average utilization.

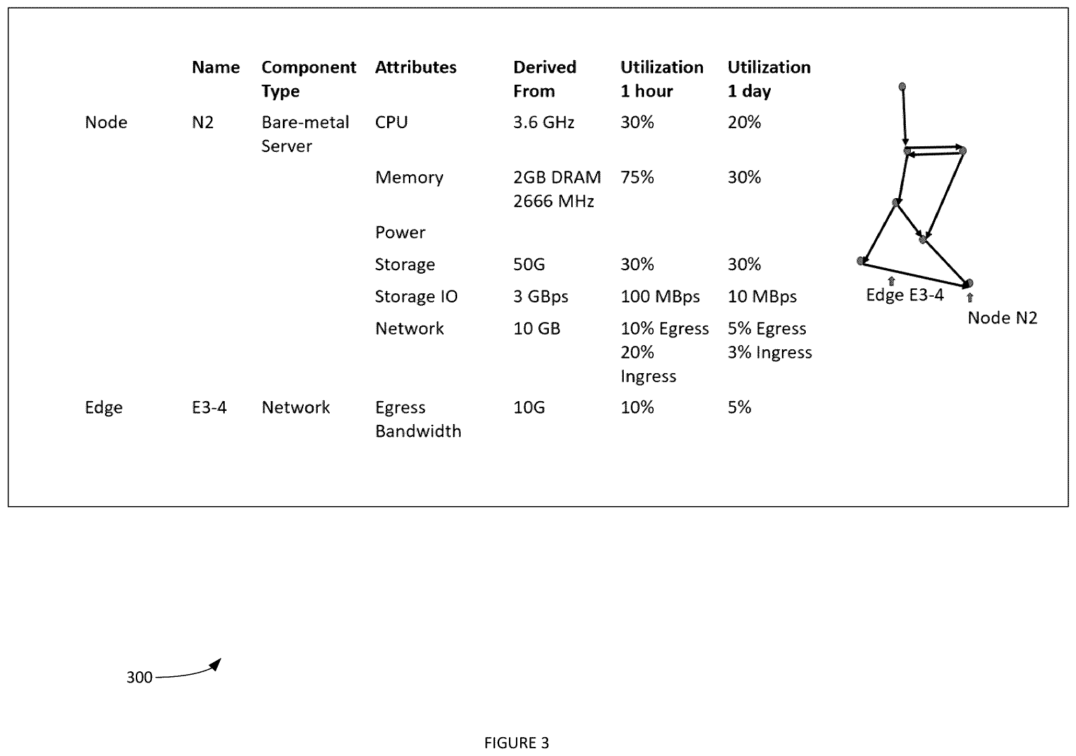

FIG. 3 illustrates an example table of components resource utilization for on-premise model, according to some embodiments. On premise could be similar to IaaS as well with resources associated with each component such as a server having specific type of CPU, Memory or storage and they are running with a specific average utilization or an edge specifying the network between to components which would be a specific type (10G or 40G or 100G) and running with a specific average utilization.

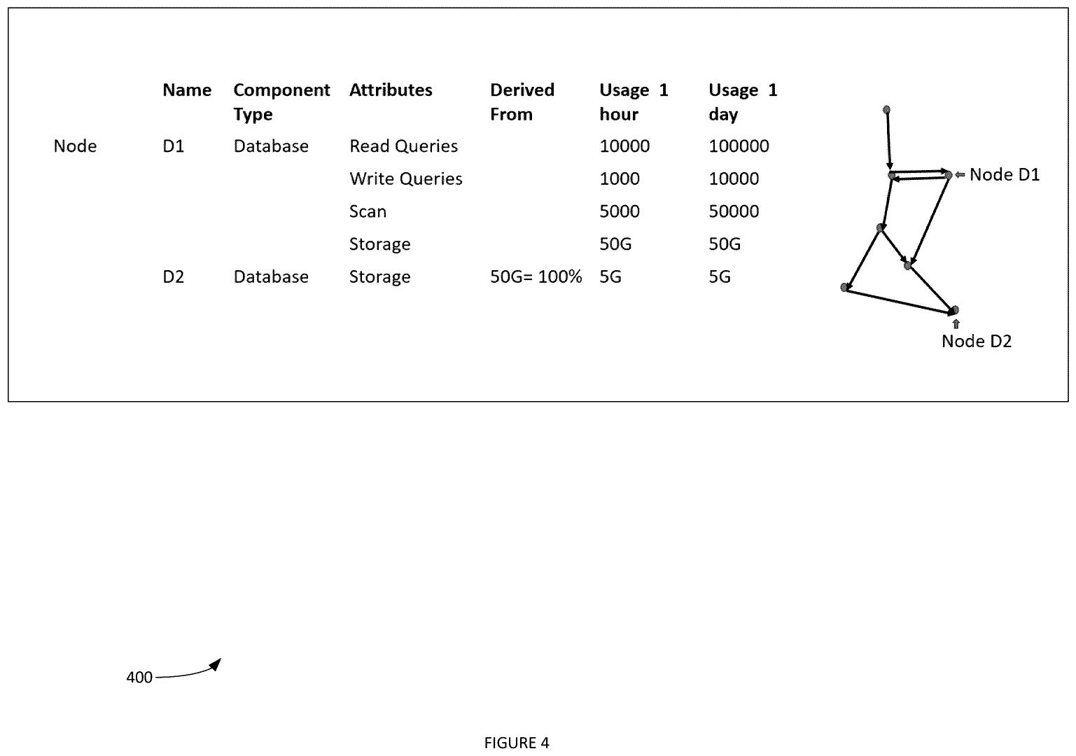

FIG. 4 illustrates an example table of components resource usage for PaaS model, according to some embodiments. With PaaS, unlike IaaS or On-premise where component types and their average utilization is calculated, with PaaS model, average usage of a functionality or a feature is calculated. This could be number of database calls made or number of API calls made.

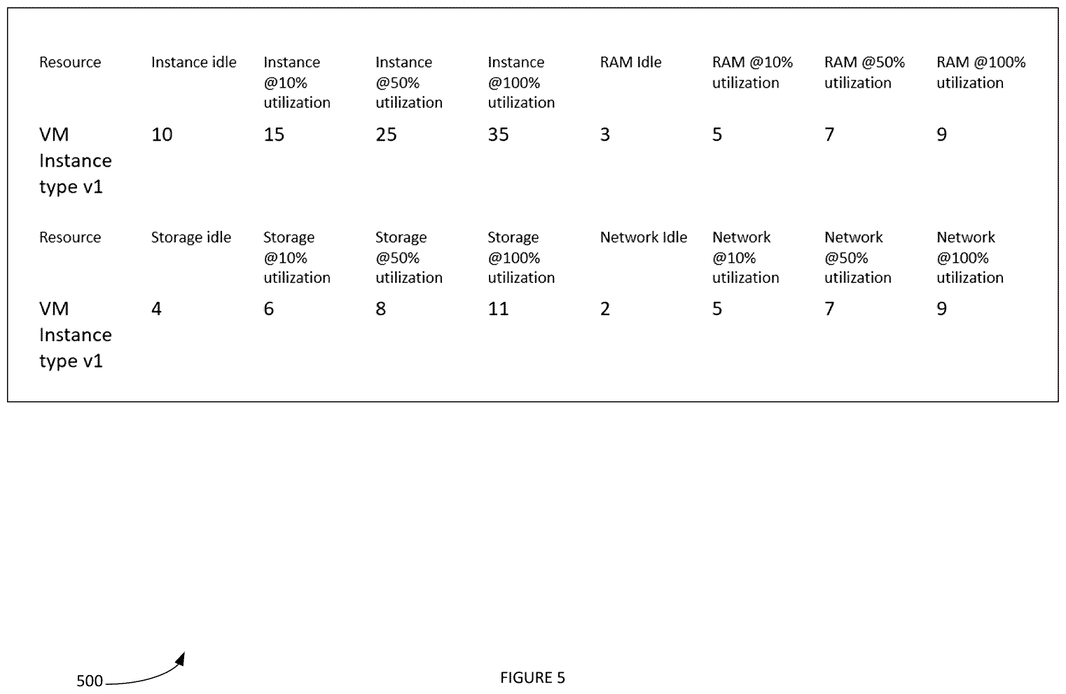

FIG. 5 illustrates an example table of energy consumed in kw (kilo watt) for one (1) hour over average utilization specified, according to some embodiments. In one example, a virtual machine (VM) instance running CPU utilization of 10%, with memory utilization at 50%, having attached Storage utilized at 10% and Network utilized at 10% consumes total wattage of 15+7+6+5=23 kw over the last one (1) hour. Similarly electricity metering for a bare-metal server on premise can be calculated at different utilization for different specifications (different CPU types, different memory, storage) averaged over 1 hour (and other time periods)

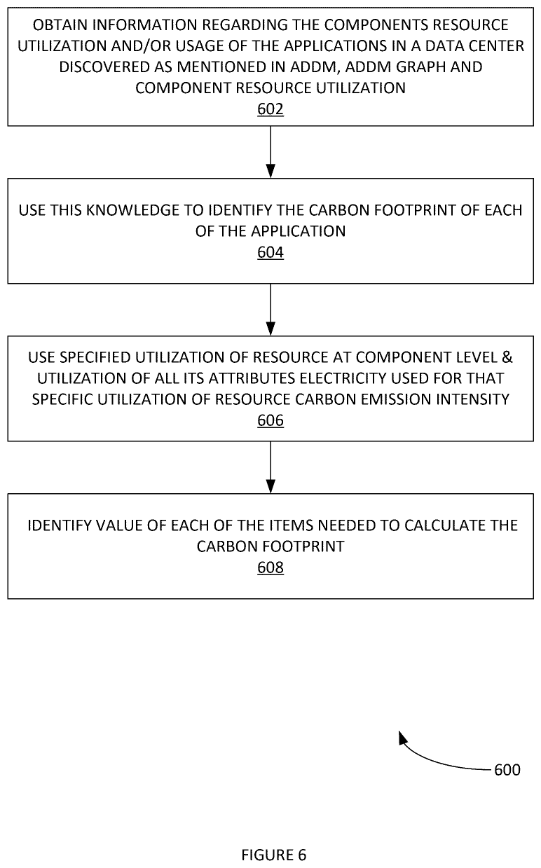

FIG. 6 illustrates an example process 600 for using components resource utilization and/or usage of the applications in a data center discovered to identify the Carbon footprint of each of the application, according to some embodiments. In step 602, process 600 obtains information regarding the components resource utilization and/or usage of the applications in a data center discovered as mentioned in ADDM, ADDM graph and Component Resource Utilization.

In step 604, process 600 uses this knowledge to identify the carbon footprint of each of the application. The carbon footprint of each of the application can be derived for various time intervals/periods. For example, derived for last one (1) hour, last one (1) day, last one (1) week, last thirty (30) days and so on.

To calculate the carbon footprint of the application, process 600 uses a specified utilization of the resource at component level and the utilization of all its attributes electricity used for that specific utilization of the resource Carbon Emission Intensity in step 606. In some embodiments, this can be a measure of grams equivalent of CO2 released per kilowatt-hour of electricity. It is noted that Carbon Emission Intensity can vary throughout the data if more solar is used during day and other energy resource used to generate electricity during night.

In step 608, process 600 identifies the value of each of the items needed to calculate the carbon footprint. This can include information about the utilization of the resource at component level and the utilization of all its attributes. This value can be provided by a Components Resource Utilization methodology in step 610 which calculates average utilization for a specified period (e.g. the last one (1) hour, last one (1) day, etc.). This method provides for each component, what is the utilization of various attributes of the components (e.g. for the last one (1) hour, last one (1) hour the VM instance had CPU at 25% average utilization and memory at 50% utilization and 10% disk access and 50% network usage, etc.).

It is noted that here idle, 10%, 50% and 100% can be taken. More finer values such as percentages at 5, 10, 15, 20, 25, etc. can be calculated for each attribute to get more precise values electricity used for that specific utilization of the resource. These can be energy constants or energy coefficients which are made public by the cloud service providers for different resources at varying load or utilization (e.g. instance types, services, etc.). If this information is not made public and/or otherwise available, this can be calculated manually on individual bare-metals servers and/or in storage systems to determine the applicable energy consumption that is then mapped to a specific instances or resource. The energy constants can a table that provides for a particular type of instance (e.g. and/or other resource), these are the power in kw (kilo watt) consumed at various utilization. That is, for example, when VM instance is idle, instance is at 10% CPU utilization, the instance can be at 50% CPU utilization and at 100% CPU utilization (e.g. average utilization over one (1) hour, one (1) day or other time period, etc.) and the energy usage of the component can be calculated and on that instance. This can determine what is the kilo watt for just memory when memory is at idle, 10%, 50% and 100% at usage over one (1) hour and/or a varying time period. This can determine what is the kilo watt for drives when IO being exercised at idle, 10%, 50% and 100% usage over one (1) hour and/or a varying time period. This can determine what is the kilo watt for network when network is being exercised at idle, 10%, 50% and 100% usage over one (1) hour and varying time period. In one example, the energy consumed in kw (kilo watt) for one (1) hour over average utilization specified can be calculated.

Carbon Emission Intensity can be a measure of grams equivalent of CO2 released per kilowatt-hour of electricity. Carbon Emission Intensity can vary throughout the data if more solar is used during day and other energy resource used to generate electricity during night. This is publicly available information from each city or location in the world as to how much of the electricity produced in each location, what is the CO2 released in grams when producing kilowatt-hour (kWh) of electricity expressed in gCO₂eq/kWh.

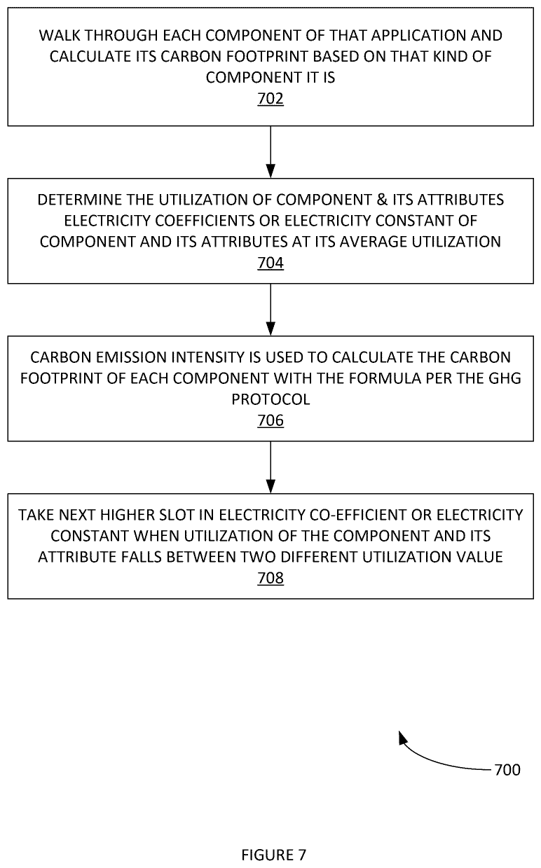

FIG. 7 illustrates an example process 700 for Carbon Footprint Calculation of the Application, according to some embodiments. To identify the carbon footprint of an individual application (for the last one-hour, last one-day, last one-week, etc.). Process 700 can walk through each component of that application and calculate its carbon footprint based on the kind of component it is (e.g. IaaS or PaaS or on-premise bare-metal, etc.) in step 702. Process 700 determines the utilization of the component and its attributes Electricity coefficients or electricity constant of the component and its attributes at its average utilization for the last one-hour (e.g. and so on and/or based on another specified time interval) in step 704.

If PaaS is used by various different applications, Cloud Providers which are providing PaaS provide overall carbon footprint based on their product (such as PaaS) for the account, process 700 can use this to identify what fraction of the total PaaS calls from all the applications in the account did the specific application make in the last 1 hour or last 1 day and use that fraction as the fraction of the monthly carbon emission as reported by the cloud provider for the account.

Carbon Emission Intensity is used to calculate the carbon footprint of each component with the formula per the GHG protocol in step 706. In step 708, process 700 can take the next higher slot in electricity co-efficient or electricity constant when the utilization of the component and its attribute falls between two different utilization value.

For example, if the average CPU utilization for last one hour is thirty-five percent (35%), process 700 obtains the electricity constant of higher value of utilization which is at fifty percent (50%) instead of the lower value which is at ten percent (10%). This can be so as to not undervalue the carbon emission. When electricity constants are calculated at smaller differences, more accurate carbon footprint can be calculated.

Process 700 can aggregate the carbon footprint of all the components calculated in the above step to obtain the overall carbon footprint of the each of the applications for the last one-hour in step 710. This methodology is repeated for different time intervals (last 1 day, last 1 week, last 1 month, etc.) in step 712.

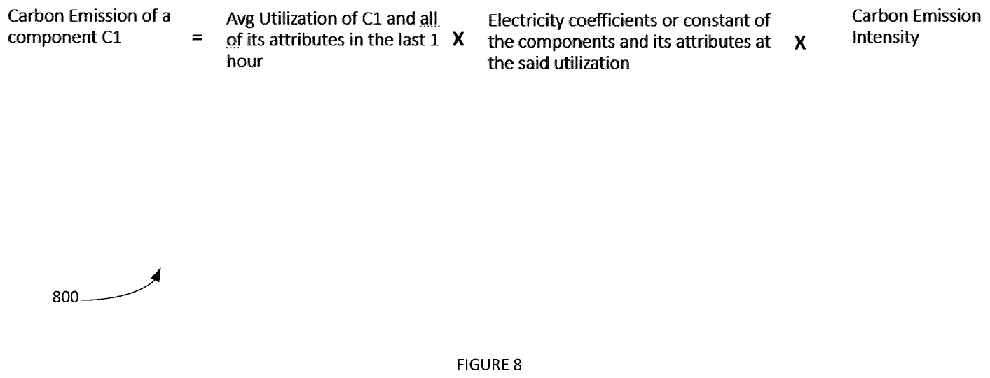

FIG. 8 illustrates an example equation 800 for calculating the carbon footprint of each component with the formula per the GHG protocol, according to some embodiments. Equation 800 can be utilized, when applicable, by the methods and processes provided supra.

When one example, an application implementing the methods and systems provided herein can be deployed in a data center, in a Cloud, Multi-Cloud (e.g. involving one or more clouds), Hybrid (e.g. which involves Cloud and On-Premise), Bare-metal on premise or an on-premise cloud (e.g. AWS Outpost, Google Anthos, Azure Azurestack, Openshift, Openstack).

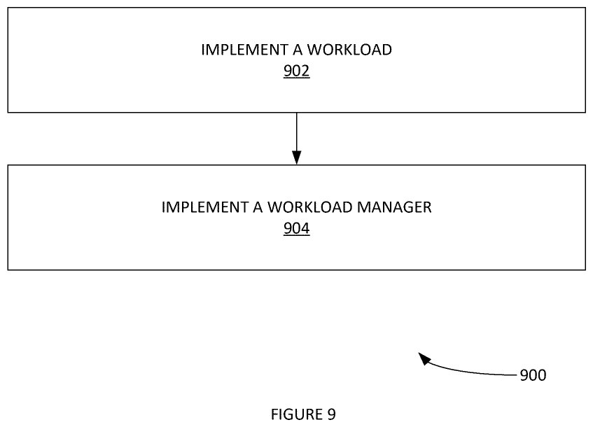

FIG. 9 illustrates an example process 900 for analysis of workloads, according to some embodiments. In step 902, process 900 can implement a workload (e.g. or a job). A workload is a collection of one or more tasks which are performed over a time period towards a specific goal. These tasks can be happening one after another in serial fashion or some disconnected tasks could be in parallel, but all are progressing step by step to achieve one or more end result(s) in the of case of a batch workload (e.g. shell script running daily maintenance) and/or could be continuously updating one or more end result(s) in case of real-time workload (e.g. streaming-analytics from IoT devices giving health updates).

A workload can span across multiple applications executing tasks from these various applications. Examples of tasks could include and not limited to data collection, streaming analytics, database query, analyzing data, data cleansing, running AI functions, reporting.

In step 904, process 900 can implement a workload manager. A workload manager executes the tasks in the workload. The path of execution of these task is defined as the workflow. The workload manager could be a simple shell script calling one task after the other an automation framework any methodologies or processes used to manage workload anything that verifies the status of a task and restart the task as needed.

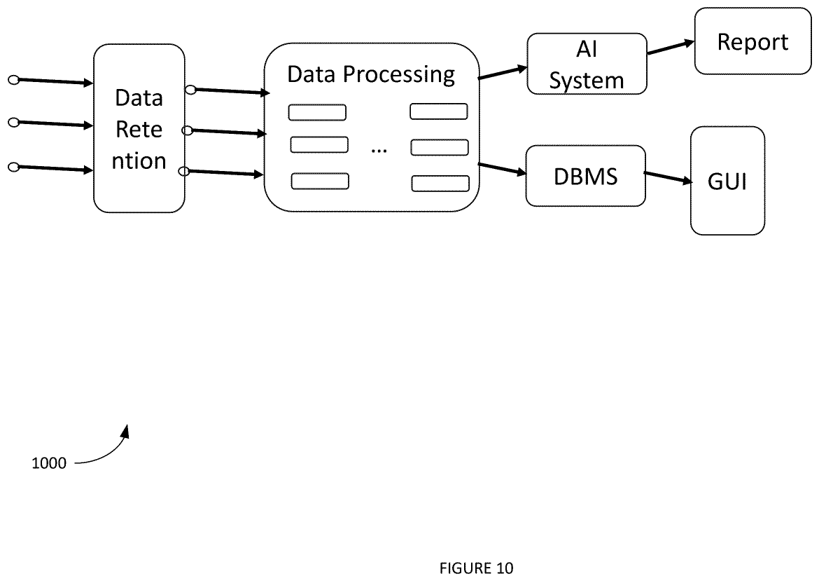

FIG. 10 illustrates another example process for, according to some embodiments. Process 1000 can be used to inform implementations of process 900 in some examples.

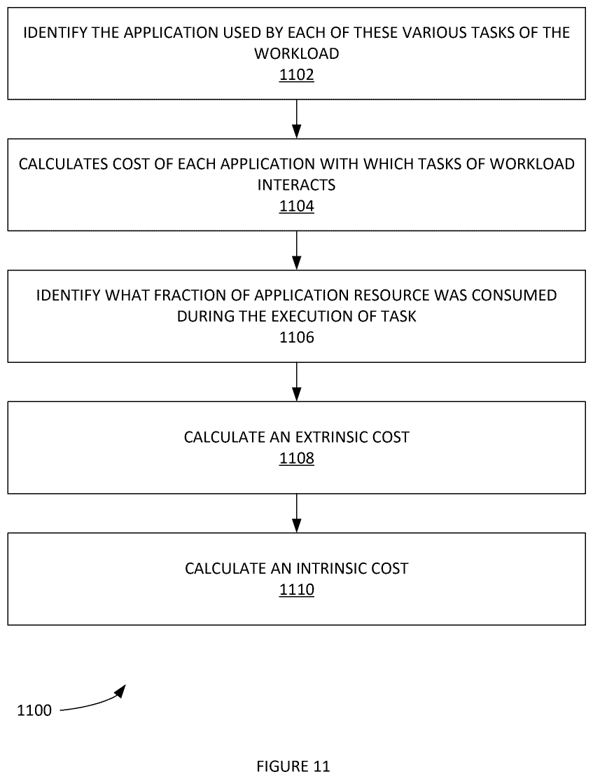

FIG. 11 illustrates an example process 1100 for calculating a cost of a workload in a data center, according to some embodiments. It is noted that calculating the cost of a workload in a data center describes steps and methodology to identify individual cost of a workload running in the data center.

Process 1100 identifies cost of running a workload. To identify the cost of running a specific workload, process 1100 identifies all the various tasks which are part of the workload, this is managed by workload manager. Process 1100 can identify the application used by each of these various tasks of the workload in step 1102. Process 1100 calculates the cost of each application with which the tasks of the workload interacts with 1104. Process 1100 identifies what fraction of the application resource (e.g. utilization when using infrastructure or usage in when using services) was consumed during the execution of the task in step 1106.

The total cost of the workload is the summation of the fraction of the application cost of all tasks running across various applications. Here, the total cost of the workload is calculated as two different costs. Process 1100 can calculate an extrinsic cost in step 1108. The extrinsic cost can be where the cost of the workload varies based on how well the applications are utilized with multiple jobs. Process 1100 can calculate an intrinsic cost in step 1110. The intrinsic cost can be an absolute cost of the workload where the workload cost is largely independent of other workloads using the same resources and doesn't drastically vary when more workloads are using same resource.

Both the extrinsic cost and intrinsic cost are important as extrinsic cost tells how well the resources are used or whether the resources are over-provisioned heavily. The intrinsic cost can be used to identify actually how much the workload cost and can be used as a measure to migrate workloads to cheaper options.

Here, the extrinsic cost of the workload or job is calculated as what fraction of the entire applications was used by each task compared to all other tasks. If only one task was running in the application, its extrinsic cost is 100% of the application cost for that time duration of the cost. If two tasks A and B were running on the application and if task B uses 2 times more resource than task A, extrinsic cost of task A=x/(2x+x)*cost of application for that time duration of the cost. For example, when no tasks are running on the application, if the baseline utilization is ‘x’.

Extrinsic cost of the workload or job is calculated as what fraction of the entire applications was used by each task compared to all other tasks. If only one task was running in the application, its Extrinsic cost is 100% of the application cost for that time duration of the cost If two tasks A and B were running on the application and if task B uses 2 times more resource than task A, extrinsic cost of task A=x/(2x+x)*cost of application for that time duration of the cost.

### Calculate Carbon Cost of Individual Workload (KGCO₂E)

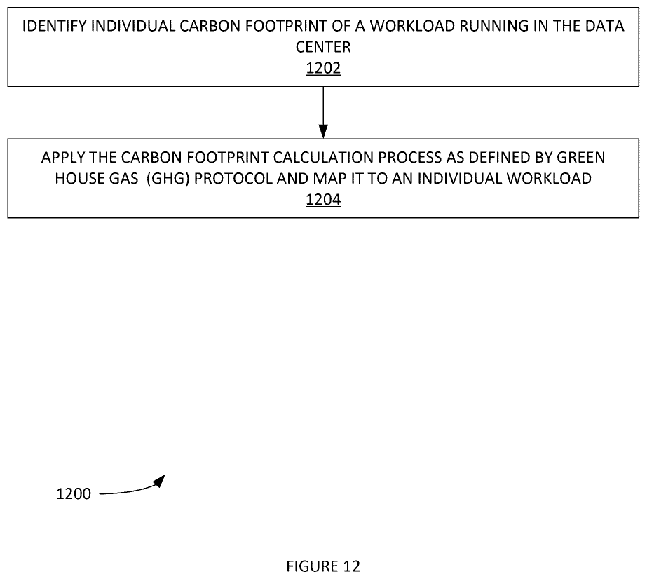

FIG. 12 illustrates an example process 1200 for calculating carbon cost of individual workload, according to some embodiments. In step 1202, process 1200 can identify individual carbon footprint of a workload running in the data center.

In step 1204, process 1200 can apply the carbon footprint calculation process as defined by Green House Gas (GHG) Protocol and map it to an individual workload. In step 1206, process 1200 identifies the carbon footprint at the workload level and not the infrastructure or services level.

Process 1200 can calculate a carbon footprint as well. Process 1200 can use components resource utilization and/or usage of the applications within workloads running in a data center discovered as mentioned in ADDM, ADDM graph and Component Resource Utilization, we use this knowledge to identify the carbon footprint of each of the workload.

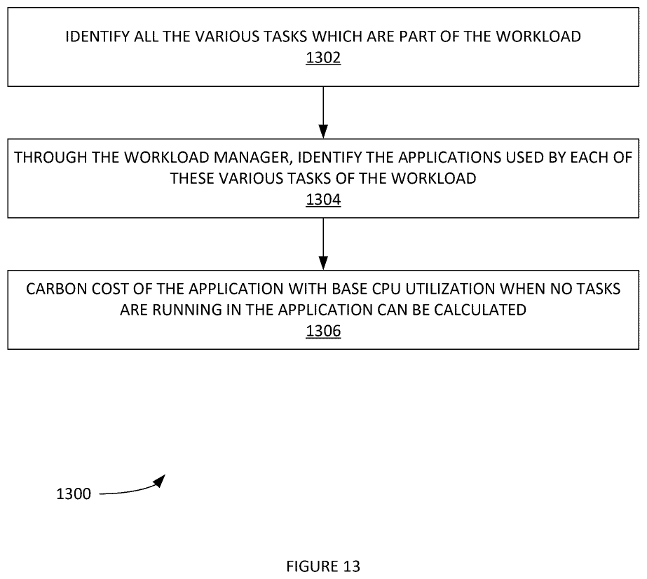

FIG. 13 illustrates an example process 1300 for identifying intrinsic carbon cost of running a workload, according to some embodiments. In step 1302, process 1300 can identify all the various tasks which are part of the workload. This is managed by workload manager. The workload manager could just be a shell script running one job after the other or could be enterprise grade workload manager. Through the workload manager, process 1300 can identify the applications used by each of these various tasks of the workload in step 1304.

It is noted that the resources of each of the application can be consumed by the tasks of the workload when operating on the applications. That is, if the application was consuming 30% CPU when no other tasks where running on the application, by the introduction of the task of the workload on the application, the CPU utilization increased to 50%. Other resources such as network, IO, memory could also be consumed additionally during the task and could be calculated similarly. It is noted that extrinsic cost is calculated as a fraction, that comes next.

Intrinsic carbon cost of the application with base CPU utilization when no tasks are running in the application can be calculated in step 1306. For example, if there is a value as cb Carbon cost of the application with increased CPU utilization when the task of the workload is running in the application is calculated, say its value is ct. The carbon cost of the task running on that application is ct-cb If base CPU utilization is not known, then for cb, the utilization of the CPU and other compute resources before the task is run is taken and carbon cost is calculated on that to give cb.

Another example is now discussed. If the workload A spans across 4 applications, if the base line of the resource when no jobs (and/or workloads) are running is 20% of average CPU utilization (e.g. this could be different for different applications like network utilization, memory, IO bandwidth, IOPS or a combination based on the application type of being CPU intensive or CPU and Memory intensive) and runs on each for 5 mins, and the tasks introduced in these applications increase in average CPU utilization to be 30%, 40%, 50% and 60%, we use this increase in CPU utilization data or increase in utilization data of any other resource to calculate the carbon cost introduced by this task.

Another example is now discussed. When a carbon cost of workload A considers the difference between the carbon cost of running the tasks on applications a1, a2, a3 and a4 when the task is running on it at 30%, 40%, 50% and 60% utilization and then reduce that value for each application with the carbon cost when run at the base utilization of 20% for all the applications. This difference in carbon cost is summed for each application to provide us the carbon cost of the task. It is noted that these examples can be combined in various permutations.

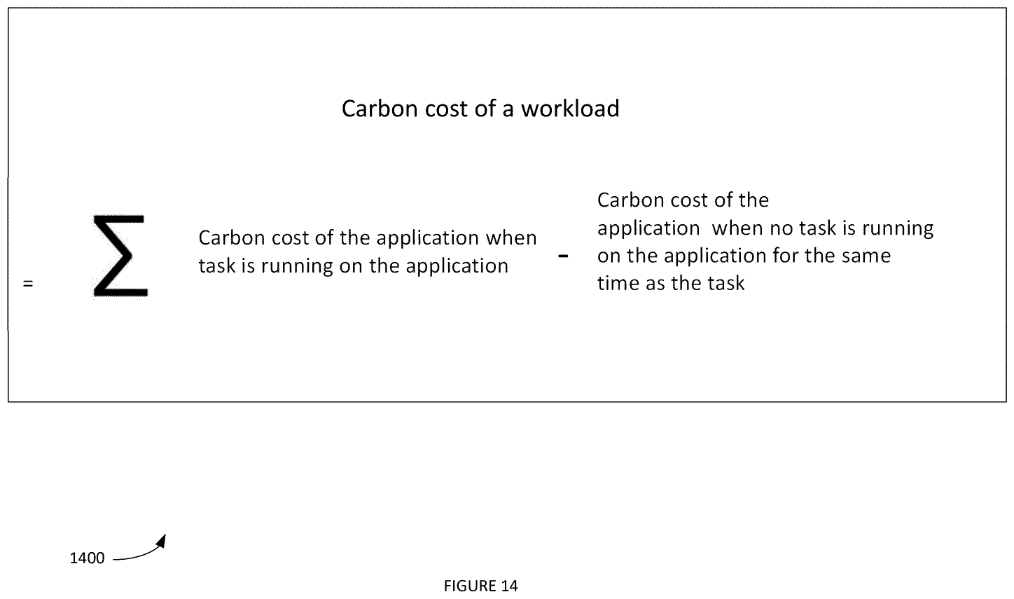

FIG. 14 illustrates an example equation for calculating the intrinsic carbon cost of a workload, according to some embodiments. A intrinsic carbon cost of the workload can the summation of the difference of the carbon cost of the application when only the task is running on the application with the carbon cost of the application when no other tasks are running on the application, and this is done for all the tasks of the workload running on all the different applications. If the carbon cost of the application when no tasks can be calculated, then carbon cost of the application before running the task on the application can be used.

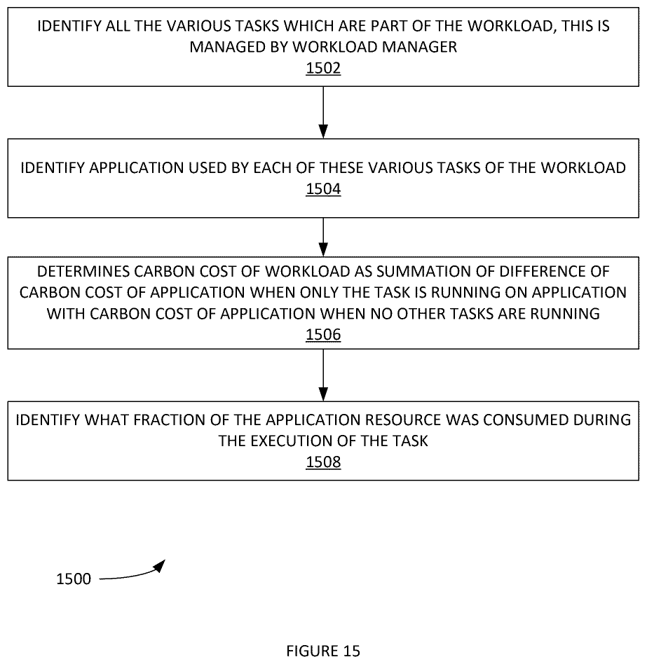

FIG. 15 illustrates an example process 1500 for identifying both intrinsic and extrinsic carbon cost of running a workload, according to some embodiments. In step 1502, process 1500 identifies all the various tasks which are part of the workload, this is managed by workload manager. In step 1504, process 1500 identifies the application used by each of these various tasks of the workload. In step 1506, process 1500 determines the carbon cost of the workload as the summation of the difference of the carbon cost of the application when only the task is running on the application with the carbon cost of the application when no other tasks are running on the application, and this is done for all the tasks of the workload running on all the different applications. In step 1508, process 1500 can identify what fraction of the application resource (e.g. utilization when using infrastructure or usage in when using services) was consumed during the execution of the task. This is the extrinsic carbon cost of the workload.

Processes 1200-1300 and 1500 can be used from the CIO to the data enter manager looking to reduce the overall footprint in the data center and can be a real-time monitoring tool for the application. Processes 1200-1300 and 1500 can used to identify high carbon footprint workloads so that these workloads can be optimized for lower carbon footprint, re-architected or re-scheduled or even deprioritized. There can be variations in utilization and carbon footprint time windows. There can be variations in electricity coefficients or electricity constants (e.g. idle, 10% utilization, 50% utilization and 100% utilization, by way of example).

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method for calculating a carbon cost of individual workload in a data center comprising:
performing Application Discovery and Dependency Mapping (ADDM) of one or more individual applications of the data center;
with an ADDM output from the ADDM, generating an ADDM graph;
determining each component of each individual application of one or more individual applications of the data center, wherein a component comprises a hardware component or a software component of each individual application;
implementing a components mapping of each component of each individual application into the ADDM graph, wherein, with the ADDM graph, a plurality of components are represented as nodes and the connectivity between the nodes represented as edges, wherein based on a knowledge of the data-center environment, wherein each component is identified to correspond to each hardware component or each software component;
implementing a workload in the data center, wherein the workload comprises a set of one or more tasks which are performed over a time period towards a specific goal;
implementing a workload manager, wherein the workload manager executes the set of tasks in the workload, wherein a path of execution of the set of tasks is defined as the workflow; and
with the ADDM, ADDM graph and Component Resource Utilization, calculating a carbon cost of individual workload in a data center of the workload to generate a carbon footprint calculation.

2. The method of claim 1 further comprising:
applying the carbon footprint calculation process as defined by a Green House Gas (GHG) Protocol.

3. The method of claim 2, wherein the carbon footprint calculation is identified at the carbon footprint at the workload level.

4. The method of claim 3 further comprising:
mapping the carbon footprint calculation process as defined by a Green House Gas (GHG) Protocol to an individual workload.

5. The method of claim 4, wherein the carbon cost of the workload comprises an intrinsic carbon cost that comprises a summation of the difference of the carbon cost of the application when only the task is running on the application with the carbon cost of the application when no other tasks are running on the application and this is done for all the tasks of the workload running on all the different applications.

6. The method of claim 5, wherein the carbon cost a carbon cost of the application when no tasks can be calculated.

7. The method of claim 6, wherein the carbon cost of the application before running the task on the application is used.

8. The method of claim 7 further comprising:
identifying the application used by each of these various tasks of the workload.

9. The method of claim 8 further comprising:
identify what fraction of the application resource is consumed during the execution of the task as an extrinsic carbon footprint.

10. The method of claim 9, wherein the fraction of the application resource is identified for a utilization when using a specified infrastructure or specified service.

11. The method of claim 10, wherein the carbon footprint calculation is used to reduce an overall footprint in the data center.

12. The method of claim 11, wherein the carbon footprint calculation is provided to a real-time monitoring tool for the application.

13. The method of claim 12, wherein the step of calculating the cost of running the workload in the data center further comprises:
calculating an extrinsic cost of running the workload in the data center.

14. The method of claim 12 further comprising:
optimizing the high-cost workloads for lower cost.

15. The method of claim 14, wherein the optimization of the high-cost workloads comprises re-architecting the high-cost workload.

16. The method of claim 14, wherein the optimization of the high-cost workloads comprises rescheduling the high-cost workload.

17. The method of claim 14, wherein the optimization of the high-cost workloads comprises deprioritizing the high-cost workload.
